(19) United States
(12) Patent Application Publication
(10) Pub. No.: US 2005/0271932 A1
(43) Pub. Date: Dec. 8, 2005

(54) Air cathode having multiple layered sintering structure and its process for producing the same

(75) Inventor: Kuei Yung Wang Chen, Taipei (TW)

Correspondence Address: BACON & THOMAS, PLLC, 625 SLATERS LANE, FOURTH FLOOR, ALEXANDRIA, VA, 22314, US

(73) Assignee: NAN YA PLASTICS CORPORATION, Taipei (TW)

(21) Appl. No.: 11/092,738

(22) Filed: Mar. 30, 2005

(30) Foreign Application Priority Data
Jun. 2, 2004 (TW) 093115761

(51) Int. Cl. H01M 4/96; H01M 4/88

(52) U.S. Cl. 429/44; 502/101; 429/42

(57) ABSTRACT

An air cathode having multiple layered structure formed by at least a layer of base material, two sintered diffusion layers and a sintered activation layer in laminating shape wherein the base material is as the electric current collector which is made of metal wire net or metal foam net carrying at least two sintered diffusion layers made of hydrophobic carbon material by sintering attached to upper and bottom side in laminating shape; additionally, one of the sintered diffusion layer on the base material carries at least one sintered activation layer which is made of hydrophilic carbon material carrying transition metal oxide catalyst; the air cathode shall be used as a cathode for Zn/Air cell, Fuel Cell or electric capacitor particularly to prevent electrolytic solution from being affected by the environment air outside the Zn/Air cell and to enable the Zn/Air cell under dry environment condition to maintain a stable electric property for a long period of time.

### BACKGROUND OF THE PRESENT INVENTION

1. Field of the Present Invention

The invention relates to an air cathode having multiple layered sintering structure and its manufacturing method, particularly a new electrode structure designed for being used as the cathode of Zn/Air cell possessing the effect of preventing the electrolytic solution inside the Zn/Air cell from being affected by the environment air.

2. Description of Prior Act

The Zn/Air cell using oxygen molecule in the air as the reactant of cathode has been considered as the substitute of alkaline cell due to its features of high specific energy and stable output voltage of electric discharge, particularly, the wide range of application including the cell for automobile, the cell for hearing aid on which the Zn/Air cell is used as power supply device as well as the features of its superiority in the application for environmental protection and low production cost.

This type of Zn/Air cell uses metal zinc (Zn) as anode and the oxygen in air (O₂) or pure oxygen as cathode, so the cathode of Zn/Air cell is also called Air cathode, the electrolytic solution inside the Zn/Air cell is potassium hydroxide (KOH) solution with which the oxygen in the air undergoes cathode chemical reaction at first to form hydroxide (OH) ion and then the zinc anode formed by zinc mixture (zinc syrup, zinc plate or zinc foil) undergoes oxidation reaction to generate stable output of electric discharge voltage. Since the air cathode of the Zn/Air cell is only used as the medium which will not cause loss of itself, therefore during production the amount of zinc anode loaded can be increased so as to increase the capacitance and specific Energy, and therefore to achieve the goal of miniaturization of the Zn/Air cell.

However, this type of Zn/Air cell must be equipped with air passage holes to let air enter the cell, this requires that the housing of the Zn/Air cell should not be made into hermetic type structure, but should be made into semi-open type structure. This semi-open type structure will enable the Zn/Air cell very apt to the influence of environmental air that will detrimentally affect the function of application and reduce the working life of the cell. Particularly, the conventional air cathode structure of Zn/Air cell at present employs the single layer sintering structure which has the drawback of unable to maintain satisfied water content of zinc anode inside the cell for longer period. If the environmental air outside the cell is in high humidity condition, water can enter into the inner side of the Zn/Air cell through the air cathode that will result in dilution of the electrolytic solution, and cause drop of electric discharge voltage output, whereas if the environmental air outside the cell is in low humidity condition, the electrolytic solution inside the cell will lose its water content through air cathode which will result in the dried up of the electrolytic solution to cause failure of generating electric discharge voltage.

### SUMMARY OF THE PRESENT INVENTION

In view of the above-mentioned problem the major purpose of the invention is to provide an air cathode having multiple layered sintering structure which can be used as the cathode of Zn/Air cell and fuel cell or used as electric capacitor. And by applying the multiple layered isolating structure which contains at least two sintered diffusion layers and a sintered activation layer the purpose of decreasing the amount of water passing through the multiple layered structure can be effectively achieved, therefore, when the invention is used as the cathode of the Zn/Air cell the interference on the electrolytic solution by the environmental air outside the cell can be avoided that can effectively solve the problem of unable to maintain the water content in normal condition for longer period, particularly, the water content of zinc anode of the Zn/Air cell can be maintained in a normal condition for a period over one month that enables the Zn/Air cell to maintain stable electric property for longer period.

Another purpose of the invention is to provide a production method for producing air cathode which employs the techniques of dry type coating with carbon powder, high pressure press biding and sintering to produce the high density air cathode having multiple layered sintering structure which when used as the cathode of the Zn/Air cell can prevent the inference due to environmental air on the electrolytic solution inside the cell that enables the water content of zinc anode of the Zn/Air cell can be maintained in normal condition for longer period, particularly can enable the Zn/Air cell to maintain stable electric property for a longer period under dry environmental condition.

### BRIEF DESCRIPTION OF THE DRAWING FIGURES

FIG. 1 is the schematic drawing of the first kind laminating shaped multiple layered sintering structure of the air cathode of the invention.

FIG. 2 is schematic drawing of the second kind laminating shaped multiple layer sintering structure of the air cathode of the invention.

FIG. 3 is schematic drawing of the third kind laminating shaped multiple layer sintering structure of the air cathode of the invention.

FIG. 4 is the manufacturing process flow diagram of the air cathode of the invention.

FIG. 5 is the IV electric property analysis curve of the air cathode of the invention.

FIG. 6 shows the variation of water content of zinc anode of the Zn/Air cell using the air cathode as cathode and the conventional single-side air cathode as cathode for comparison measured after the cells were kept in dry air environment under temperature of 25° C. and humidity of 20 RH % for a period of 7 days.

FIG. 7 shows the variation of utilization ratio of zinc anode of Zn/Air cell using the air cathode as cathode of the invention and the conventional single-side air cathode as cathode for comparison measured after the cells were kept in dry air environment under temperature of 25° C. and humidity of 20 RH % for a period of 7 days.

### DETAILED DESCRITION OF THE PREFERRED EMBODIMENTS

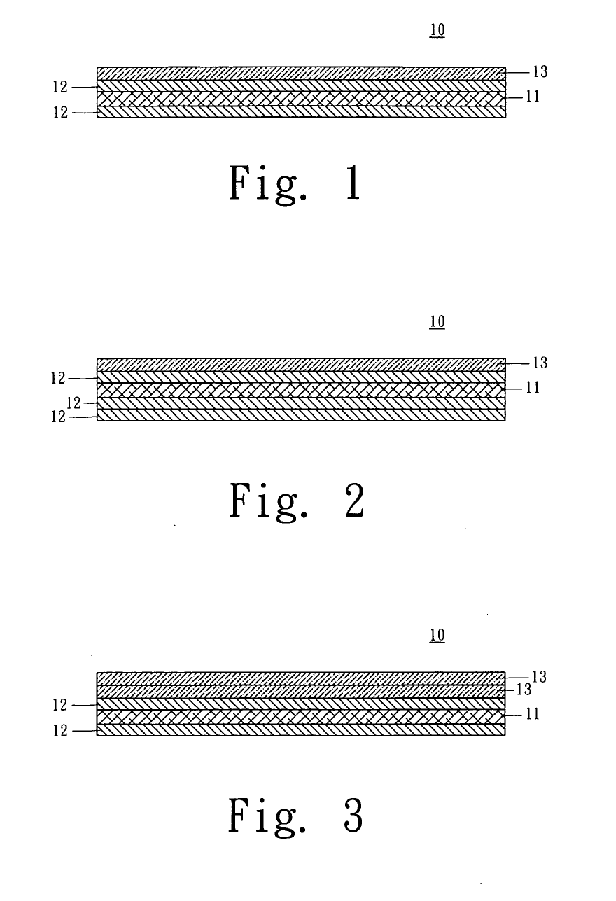

As illustrated in from FIG. 1 to FIG. 3, the air cathode 10 of the invention has a multiple layered structure which has the effect of reducing the passing of water through the layered structure. The structure comprises a layer of base material 11, at least two sintered diffusion layers 12 and at least one sintered activation layer 13 formed into multiple layered structure. The thickness of the air cathode 10 is within a range of 0.8˜2.0 mm, and the: density is within 0.1˜30.0 g/cm³ with range of application including used as cathode of Zn/Air cell and fuel cell or for electric capacitor.

The air cathode 10 of the invention uses the base material 11 as the electric current collector which is made of metal net such as nickel net, and the type of metal net shall include metal wire net, metal wire weaving net and metal foam net.

To both sides of the base material 11 two sintered diffusion layers 12 having thickness of 0.2˜0.8 mm are attached in layered or laminated shape, or more than one sintered diffusion layer 12 are attached to the bottom side, and the sintered diffusion layer 12 is made of hydrophobic carbon material.

The purpose of choosing hydrophobic carbon material to form the sintered diffusion layer 12 is to achieve the function of allowing air entering the cell but preventing the electrolytic solution inside the Zn/Air cell from being affected by the environment air to prevent any change of the composition of the electrolytic solution inside the cell when the air cathode 10 of the invention is used as cathode of the Zn/Air cell that shall enable the water content of zinc anode of the Zn/Air cell to be maintained in normal condition for longer period.

Besides, on the outer side of the sintered diffusion layer 12 of the base material 11 at least one sintered activation layer 13 made of hydrophilic carbon material is formed into laminated shape.

The purpose of choosing the carbon material which carries catalyst for forming the sintered activation layer 13 is to activate oxygen to undergo cathode chemical reaction and transfer to hydroxide ion, and through the chemical reaction between the electrolytic solution and the zinc metal of anode the electric current can be generated. The catalyst adhered to the sintered activation layer 13 can be of the oxide or salt of transition metal such as iron, cobalt, nickel and manganese.

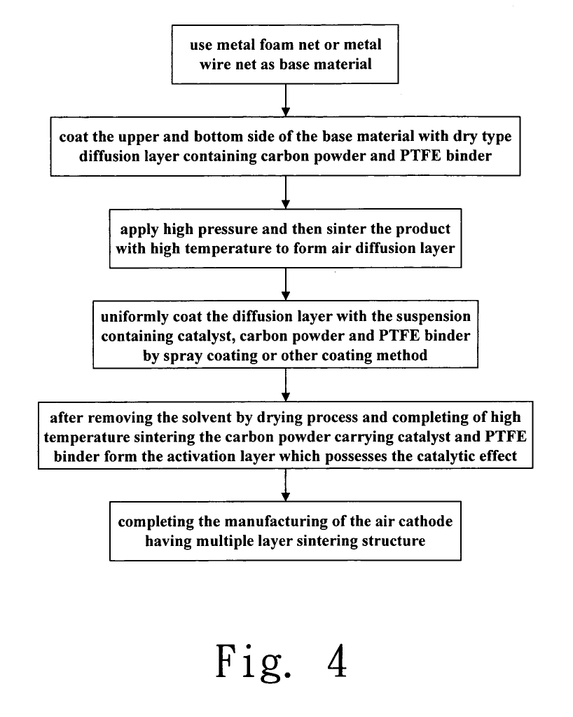

The production process of the air cathode 10 of the invention is shown in FIG. 4 which also includes the following steps: a) make electric current collector of the air cathode 10 using metal foam net or metal wire net as base material 11; b) make sintered diffusion layer 12 of the air cathode;

b-1) mix the hydrophobic carbon powder or carbon material such as acetylene reduced carbon black or coking carbon black with polytetrafluoroethylene (PTFE) water soluble suspension binder and deionized water in the proportion of 2:1:50 or 3:1:50;

b-2) followed by carrying out heat drying of the mixture of hydrophobic carbon powder and PTFE binder, one of the preferred example of embodiment is drying the mixture to achieve a water content less than 4%;

b-3) after completion of drying process uniformly coat both sides of the base material 11 with the mixture of PTFE binder and carbon powder, and than apply high pressure on both sides to make the hydrophobic carbon powder tightly bound together;

b-4) apply high temperature (200˜400° C.) on the base material 11 carrying hydrophobic carbon powder obtained from step b-3 to undergo sintering process for 20˜40 min., however the more preferred embodiment is to apply temperature of 300˜350° C. for a time period of 20˜40 min to undergo the sintering process to enable the mixture of PTFE binder and hydrophobic carbon powder to from rigid type carbon powder with net shaped structure to obtain the sintered diffusion layer 12 of the air cathode 10, then the thickness of the sintered diffusion layer 12 is further adjusted to 0.2˜0.8 mm by roller press machine; and

b-5) If more than two layers of sintered diffusion layer 12 is needed, repeat the step in b-3 and b-4 until multiple layered structure is obtained. c) make the sintered activation layer 13 of air cathode 10;

c-1) mix the hydrophilic carbon powder or carbon material such as acetylene reduced carbon black, coking carbon black, nanometer carbon tube or nanometer carbon horn with PTFE binder and transition metal oxide catalyst powder in the proportion of 4:1:1 or 3:1:2, and then add water or methyl alcohol or isopropyl alcohol into the mixture as solvent to form uniform syrup wherein the transition metal oxide catalyst powder may be the oxide or salt of iron, cobalt, nickel or manganese;

c-2) then coat the surface of the sintered diffusion layer 12 on the upper side of the base material with the syrup mixture obtained from step c-1 by spray gun or other means to form the sintered activation layer 13;

c-3) apply high temperature (200˜400° C.) on the base material 11 obtained from step c-2 carrying sintered diffusion layer 12 and sintered activation layer 13 to undergo sintering process for 10˜60 min., however the more preferred example of embodiment is to heat the base material to a temperature as high as 350° C.-400° C. for 20˜40 min. to obtain rigid type carbon powder containing transition metal oxide catalyst powder by sintering the mixture of PTFE binder, transition metal oxide catalyst and hydrophilic carbon powder to form the sintered activation layer 13 of the air cathode 10, and then adjust the thickness of the sintered activation layer 13 to a thickness of 0.2˜0.8 mm. To obtain the air cathode 10 having laminated multiple layer sintering structure; and

c-4) if a structure having more than two sintered activation layers is needed, the steps in c-2 and c-3 shall be repeated until the desired multiple layered structure is obtained.

### PRACTICAL APPLICATION OF THE INVENTION

The structure of the air cathode 10 of this example is shown in FIG. 1. Use nickel net as the base material 11, and the electric current collector of the air cathode 10 is formed in such a way that a sintered diffusion layer 12 is attached to the upper and bottom side of the nickel net, and an sintered activation layer 13 is attached to the outer side of the upper sintered diffusion layer 12 which is on the upper side of the base material 11. The air cathode 10 so obtained has thickness of 0.8 mm and a density of 0.1˜30.0 g/cm³.

In this method the sintered diffusion layer 12 is made by mixing hydrophobic coking carbon black, PTFE binder and deionized water in the proportion of 3:1:50 and then the mixture is dried, and have the nickel net coated with the dried mixture on both sides and sintered with temperature 200° C. through 20 min. The sintered activation layer 13 is made by mixing hydrophobic coking carbon black, PTFE binder, and transition metal oxide which is used as catalyst in the proportion of 4:1:1, and add methyl alcohol, isopropyl alcohol and deionized water in an amount of 500 times of the mixture by weight to dilute the mixture to form syrup mixture, then coat the surface of the sintered diffusion layer 12 on the upper side of the nickel net with the syrup mixture by means of spray gun, and sinter the nickel net with temperature 400° C. for 10 min to obtain the desired product.

Then electro-chemical analysis was carried out on the air cathode 10 of the example of embodiment including the test items of Air Cathode IV Electric Property Test, Water Content Test and Utilization Ratio Test of Anode Electric Discharge. The following test results showed that the air cathode 10 can prevent the environment air from affecting the electrolytic solution inside the Zn/Air cell, so that the water content of zinc anode can be maintained in the normal condition for a longer period of time, particularly in the dry environment when the air cathode 10 is employed, a stable utilization ratio of electric property of Zn/Air cell can be maintained for longer period.

Air Cathode IV Electric Property Test (Electric Discharge Scan Test With Electric Current Density Versus Electric Potential):

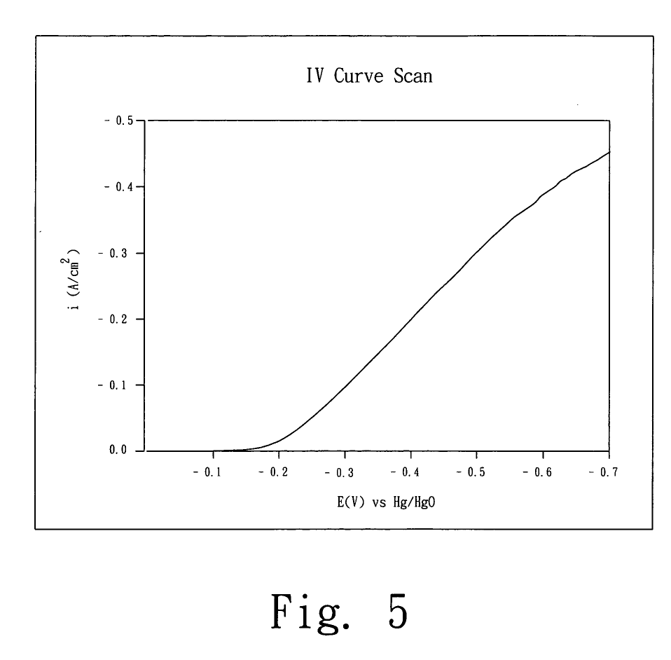

Fix the air cathode 10 made from the method of the example of embodiment by fixture, and add KOH aqueous solution and use Hg/HgO electrode as the reference electrode and Pt electrode as correspond electrode, then carry out scan analysis by electrochemical analyzer. The IV Electric Property Curve obtained from the test is shown in FIG. 5.

From the test results of IV Electric Property shown in FIG. 5, it shows that the air cathode 10 of the example of embodiment achieved an electric current density over 0.25 A/cm² when the working voltage of the test as versus the Hg/HgO reference electrode is blow-0.5V. Therefore, the air cathode 10 produced according to the method of the example of embodiment can rapidly cause the oxygen to undergo cathode chemical reaction and transfer oxygen to hydroxide ion (OH) and to generate electric current through the reaction between KOH electrolytic solution and metal anode.

The comparison between the air cathode 10 of the invention and the conventional type air cathode or gas electrode having high density or produced by high pressure process shows that the reduction of air passage hole size of the conventional air cathode or gas electrode due to high pressure processing causes the air outside the cathode unable to smoothly pass through the cathode that results in the decrease of electric performance, and the electric current density can only reaches a level of 0.025˜0.080 A/cm², but the air cathode 10 of the example of embodiment of the invention can achieve an electric current density over 0.25 A/cm².

Water Content Test:

Put the air cathode 10 of the example of embodiment of the invention into cathode metal housing having outer diameter of 8 cm and 32 circular air passage holes in an diameter of 0.85 mm uniformly distributed on the housing which is assembled together with isolating membrane or high polymer electrolyte, colloidal state zinc anode and metal housing of anode to form Zn/Air cell. The colloidal state zinc anode was made by mixing the zinc alloy powder, corrosion depressant, interface activator and KOH aqueous solution in an appropriate proportion and stirring the mixture properly.

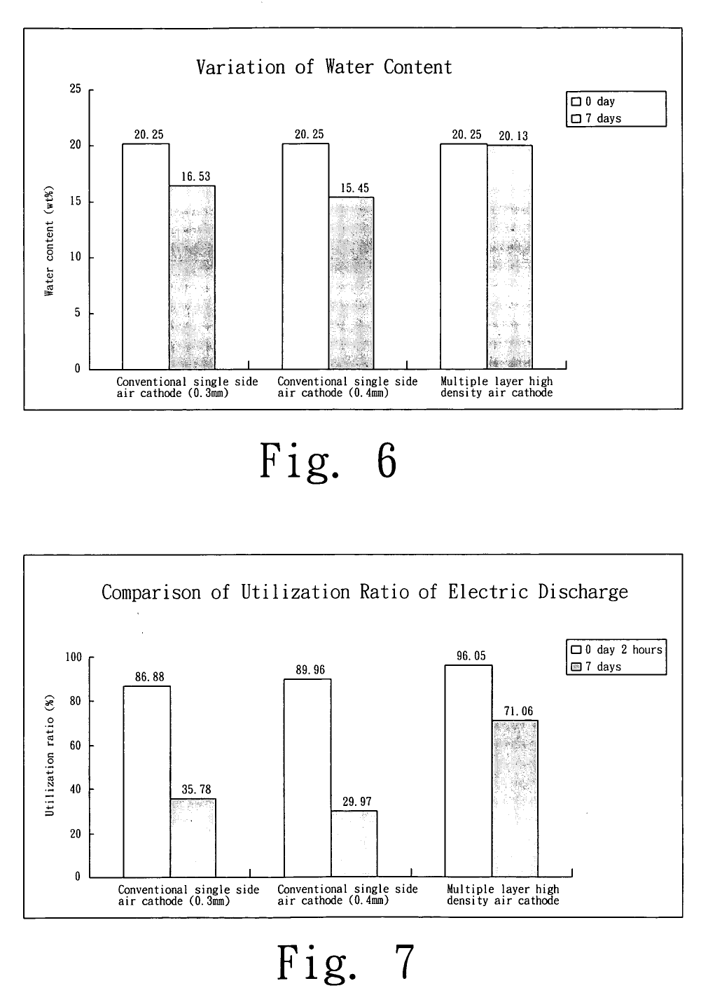

Then put the assembled Zn/Air cathode in dry air under temperature of 25° C. and humidity of 20 RH % for 7 days, and then disassembled the Zn/Air cell to test the water content of the colloidal state zinc anode by means of Water Content Tester (150° C., 35 min). The test results are shown in FIG. 6.

The samples for comparison were made by using the air cathode having single layer sintering structure with thickness of 0.3 mm and 0.4 mm, i.e. the conventional single-side air cathode to form Zn/Air cells under same condition, and the water content of the colloidal state zinc anode was tested under the same condition (105° C., 35 min), the test results are shown in FIG. 6.

From the test results of water content of the colloidal state zinc anode it shows that the air cathode 10 produced by the method described in example of embodiment, owing to its laminated multiple layer sintering structure, can effectively maintain the water content of the zinc anode of Zn/Air cell in the normal condition when used as the cathode of the Zn/Air cell.

Utilization Ratio Test of Anode Electric Discharge:

The test was carried out by using the same type of Zn/Air cell as that for testing the water content of colloidal state zinc anode, and put the anode in dry air environment under temperature 25° C. and humidity 20 RH % for 7 days, then tested the utilization ratio of the electric discharge by zinc anode of Zn/Air cell by employing electric charge/Discharge instrument under the discharge current of c15 (200 mA), the test results are shown in FIG. 7.

In the aforementioned test the utilization ratio of electric discharge by zinc anode is calculated according to the following formula:
utilization ratio (%) actual electric capacity/theoretrical electric capacity

The sample for comparison was equipped with the air cathode having single layer sintering structure with thickness of 0.3 mm and 0.4 mm, i.e. the conventional air cathode, and is made into Zn/Air cell under the same condition. The cell was then tested under the same condition for the utilization ratio of electric discharge by zinc anode, the test results are as shown in FIG. 7.

From the comparison of the test results of electric discharge by Zinc anode shown in FIG. 7 it shows that the air cathode 10 produced according to the method described in the example of embodiment of the invention is proved to have the effect of extending the working life with normal utilization ratio of Zn/Air cell which is kept in the dry air environment due to its laminating shaped multiple layer sintering structure.

1. An air cathode having multiple layered structure comprising at least a base material layer, two sintered diffusion layer and a sintered activation layer which are arranged into laminating shaped structure, wherein the base material made of metal wire net or metal foam net is served as an electric current collector particularly having both of its upper and bottom side carrying a sintered diffusion layer made of hydrophobic carbon material, and one of said sintered diffusion layers carries the sintered activation layer which is arranged on the outer side of the sintered diffusion layer made of hydrophilic carbon material carrying transition metal oxide catalyst.

2. The air cathode as defined in claim 1, wherein the air cathode has thickness of 0.8˜2.0 mm, density of 01˜30.0 g/cm³, and shall be used for Zn/Air cell and fuel cell as cathode or used for electric capacitor.

3. The air cathode as defined in claim 2, wherein the base material is made of metal net including metal wire net and metal foam net.

4. The air cathode as defined in claim 2, wherein each sintered diffusion layer is made of acetylene reduced carbon black or coking carbon black by sintering process.

5. The air cathode as defined in claim 2, wherein the catalyst carried by the sintered activation layer is oxide or salt of transition metal of iron, cobalt, nickel and manganese.

6. The air cathode as defined in claim 2, wherein the sintered activation layer is made of acetylene reduced carbon black, coking carbon black, nanometer carbon tube or nanometer carbon horn.

7. The air cathode as defined in claim 2, wherein the base material is made of nickel net, the sintered diffusion layer is made of acetylene reduced carbon black or coking carbon black, the sintered activation layer is made of acetylene reduced carbon black, coking carbon black, nanometer carbon tube or nanometer carbon horn.

8. A process for producing air cathode comprising the following steps:
(a) make electric current collector of Zn/Air cell by using metal foam net or metal wire net;
(b) mix the hydrophobic carbon powder or carbon material of acetylene reduced carbon black or coking carbon black, PTFE aqueous suspension binder and deionized water in the proportion of 2:1:50 or 3:1:50; then have the mixture of PTFE binder and hydrophobic carbon powder undergo heat drying process; after completion of heat drying process coat both the upper side and bottom side of the base material obtained in step (a) with the mixture of PTFE and hydrophobic carbon powder to form the sintered diffusion layer; then apply high pressure to make the carbon powder tightly bound together, and heat the base material carrying hydrophobic carbon powder with high temperature 200˜400° C. for 20˜40 min to sinter the mixture of PTFE binder and hydrophobic carbon powder into rigid carbon powder with net-shaped structure to form the sintered diffusion layer of the air cathode, and then adjust the thickness of the sintered diffusion layer by roller press machine; and
(c) mix the hydrophobic carbon powder or carbon material of acetylene reduced carbon black or coking carbon black, nanometer carbon tube or nanometer carbon horn, PTFE binder and transition metal oxide catalyst powder in the proportion of 4:1:1 or 3:1:2; and then add water, methyl alcohol or isopropyl alcohol to the mixture as solvent to form uniformly mixed size; then coat the surface of the sintered diffusion layer on the upper side of the base material with the mixed size by means of spray gun or other coating method to form an sintered activation layer; then heat the base material carrying sintered diffusion layer and sintered activation layer with high temperature 200˜400° C. for 10˜60 min to sinter the mixture of PTFE binder, transition metal oxide catalyst powder and the hydrophobic carbon powder to form rigid type carbon powder carrying transition metal oxide catalyst powder to form the sintered activation layer of the air cathode; and then the thickness of sintered activation layer is adjusted by roller press machine to form the air cathode having laminating shaped multiple layer sintering structure.

9. The process for producing air cathode as defined in claim 8, wherein the heat drying process described in step (b) for drying the mixture of PTFE binder and hydrophobic carbon powder is carried out in such a way that the water content of the mixture after drying is below 4%.

10. The process for producing air cathode as defined in claim 9, wherein when more than two sintered diffusion layers are to be produced the procedures for carrying out coating with carbon powder and sintering process as described in step (b) is repeated until the desired multiple layered structure is obtained, and then the thickness of the sintered diffusion layer is adjusted by roller press machine.

11. The process for producing air cathode as defined in claim 10, wherein when more than two sintered activation layers are to be produced the procedures for carrying out coating with size and sintering process as described in step (c) is repeated until the desired multiple layered structure is obtained for making the air cathode having laminating shaped multiple layer sintering structure.

12. The process for producing air cathode as defined in claim 9, wherein the sintering processing as described in step (b) is carried out in such a way that the base material carrying the hydrophobic carbon powder is heated with high temperature 300˜350° C. for 20˜40 min, and the sintering process as described in step (c) is carried out is such a way that the base material carrying the sintered diffusion layer and the sintered activation layer is heated with high temperature 350˜400° C. for 20˜40 min.

13. The process for producing air cathode as defined in claim 12, wherein when more than two sintered diffusion layers are to be produced the procedures for carrying out coating with carbon powder and sintering process as described in step (b) is repeated until the desired multiple layered structure is obtained, and then the thickness of the sintered diffusion layer is adjusted by roller press machine.

14. The process for producing air cathode as defined in claim 13, wherein when more than two sintered activation layers are to be produced the procedures for carrying out coating with size and sintering process as described in step (c) is repeated until the desired multiple layered structure is obtained for making the air cathode having laminating shaped multiple layer sintering structure.

15. The process for producing air cathode as defined in claim 12, wherein the transition metal oxide catalyst powder is the transition metal oxide or salt of iron, cobalt, nickel and manganese.

16. The process for producing air cathode as defined in claim 15, wherein when more than two sintered diffusion layers are to be produced the procedures for carrying out coating with carbon powder and sintering process as described in step (b) is repeated until the desired multiple layered structure is obtained, and then the thickness of the sintered diffusion layer is adjusted by roller press machine.

17. The process for producing air cathode as defined in claim 16, wherein when more than two sintered activation layers are to be produced the procedures for carrying out coating with size and sintering process as described in step (c) is repeated until the desired multiple layered structure is obtained for making the air cathode having laminating shaped multiple layer sintering structure.
